(19) United States
(12) Patent Application Publication
(10) Pub. No.: US 2023/0047171 A1
(43) Pub. Date: Feb. 16, 2023

(54) IMAGE FORMING APPARATUS

(71) Applicant: CANON KABUSHIKI KAISHA, Tokyo (JP)

(72) Inventors: Tetsuro Sakamoto, Chiba (JP); Takashi Hiratsuka, Chiba (JP); Ryohei Yamamoto, Tokyo (JP)

(21) Appl. No.: 17/859,147

(22) Filed: Jul. 7, 2022

(30) Foreign Application Priority Data
Aug. 16, 2021 (JP) 2021-132288

(51) Int. Cl. B65H 29/60; G03G 15/00; B65H 7/14

(52) U.S. Cl. CPC B65H 29/60; G03G 15/6552; B65H 7/14; B65H 2513/41; B65H 2801/06; B65H 2301/33312; B65H 2404/632; B65H 2513/51

(57) ABSTRACT

An image forming apparatus includes a reverse roller pair including a drive roller and a driven roller by which a recording medium is nipped and conveyed reversibly, a motor configured to rotate the drive roller reversibly, a conveyance roller pair, a detection unit configured to detect the recording medium conveyed by the conveyance roller pair, and a controller configured to control the motor, in a case in which the recording medium is detected by the detection unit, to cause the drive roller to rotate in a first rotation direction by a first rotation amount, thereafter to cause the drive motor to rotate in a second rotation direction by a second rotation amount. A difference between the first rotation amount and the second rotation amount is set to an integer multiple of a predetermined rotation amount of the motor, the predetermined rotation amount making the drive roller one rotation.

### BACKGROUND OF THE INVENTION

### Field of the Invention

The present invention relates to an image forming apparatus having a reverse roller pair configured to convey a recording medium in a first direction and a second direction opposite to the first direction.

### Description of the Related Art

Conventionally, there is an image forming apparatus having a function of performing one-sided image formation for forming an image on one side of a recording medium and double-sided image formation for forming images on both sides of a recording medium. In a case in which the image forming apparatus performs the double-sided image formation, a conveyance direction of a recording medium is reversed (switched back) so that an upstream edge (trailing edge) of the recording medium conveyed from a fixing portion becomes a leading edge. The recording medium of which the conveyance direction is reversed is conveyed through a reverse conveyance path to an image forming portion again. The image forming portion forms an image on a back side of the recording medium to perform the double-sided image formation.

Japanese Patent Application Laid-Open No. 2016-132547 and Japanese Patent Application Laid-Open No. 2008-156005 disclose image forming apparatuses in each of which a reverse roller pair is provided downstream of a fixing portion in a conveyance direction of a recording medium conveyed from a fixing portion. A rotation direction of the reverse roller pair can be switched. The reverse roller pair nips the recording medium conveyed from the fixing portion, conveys the recording medium by a predetermined amount in the conveyance direction, and thereafter reversely rotates to switch back the recording medium. Thus, the image forming apparatuses disclosed in Japanese Patent Application Laid-Open No. 2016-132547 and Japanese Patent Application Laid-Open No. 2008-156005 perform the double-sided image formation.

In recent years, however, customer demand for image quality of image forming apparatuses has been increasing. In particular, higher accuracy is desired for a geometric image quality relating to an image formation position accuracy of an image with respect to a recording medium. In the image forming apparatus disclosed in Japanese Patent Application Laid-Open No. 2016-132547, since the recording medium is reversed by only the reverse roller pair, fluctuations occur in the image formation position accuracy of the image with respect to the recording medium for each of the conveying recording medium, and the geometric image quality deteriorates.

In the image forming apparatus of Japanese Patent Application Laid-Open No. 2008-156005, since a circumferential length of the reverse roller is measured during conveyance of the recording medium and the reverse timing in the conveyance direction of the recording medium is controlled based on the measured circumferential length, the positional accuracy of the recording medium in the conveyance direction is improved. However, the image forming apparatus disclosed in Japanese Patent Application Laid-Open No. 2008-156005 has a difficulty that fluctuations in the attitude (direction) of the recording medium with respect to the conveyance direction cannot be reduced.

### SUMMARY OF THE INVENTION

According to an embodiment of the present invention, an image forming apparatus configured to form an image on a recording medium, the image forming apparatus comprises: a reverse roller pair including a drive roller configured to rotate in a first rotation direction to convey the recording medium in a first direction and rotate in a second rotation direction opposite to the first rotation direction to convey the recording medium in a second direction opposite to the first direction, and a driven roller configured to be driven by a rotation of the drive roller, the recording medium being nipped by the drive roller and the driven roller and conveyed; a motor configured to cause the drive roller to rotate in the first rotation direction and in the second rotation direction; a conveyance roller pair disposed upstream of the reverse roller pair in the first direction and configured to nip and convey the recording medium in the first direction; a detection unit disposed between the reverse roller pair and the conveyance roller pair and configured to detect the recording medium conveyed in the first direction by the conveyance roller pair; and a controller configured to control the motor, in a case in which the recording medium is detected by the detection unit, to cause the drive roller to rotate in the first rotation direction by a first rotation amount, and thereafter to cause the drive roller to rotate in the second rotation direction by a second rotation amount, wherein a difference between the first rotation amount and the second rotation amount is set to an integer multiple of a predetermined rotation amount of the motor, the predetermined rotation amount making the drive roller one rotation.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a view showing a reverse discharge portion of the image forming apparatus.

FIG. 3 is a view showing a sheet sensor and a discharge upstream roller pair.

FIG. 4A, FIG. 4B, and FIG. 4C are explanatory views of a circumferential velocity fluctuation that occurs in one rotation period of a discharge drive roller.

FIG. 5A and FIG. 5B are explanatory views of a fluctuation in a skew amount of a sheet caused by a periodic fluctuation in a difference velocity.

FIG. 6A and FIG. 6B are views showing the fluctuation in the skew amount of the sheet during a switchback.

FIG. 7 is a view showing a relationship between a conveyance distance of the sheet and a phase of the discharge drive roller.

FIG. 8 is a flowchart showing a control operation of the discharge drive roller performed by a controller according to a first embodiment.

FIG. 9A and FIG. 9B are explanatory views of an edge detecting portion.

FIG. 10 is a flowchart showing a control operation of the discharge drive roller performed by a controller according to a second embodiment.

### DESCRIPTION OF THE EMBODIMENTS

### First Embodiment

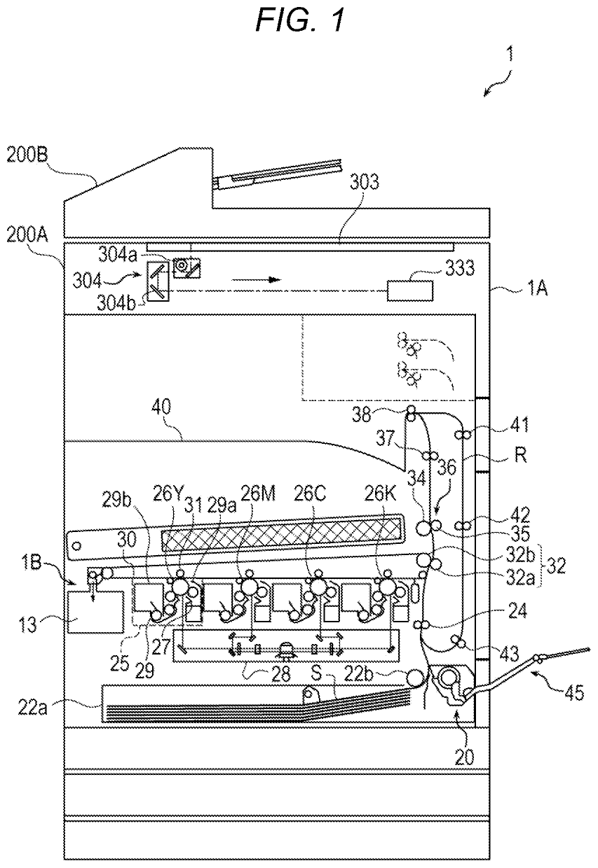

The first embodiment will be described below with reference to FIG. 1 to FIG. 8.

### (Image Forming Apparatus)

FIG. 1 is a cross-sectional view of an image forming apparatus 1. The image forming apparatus 1 has an image forming apparatus main body (hereinafter referred to as an apparatus main body) 1A. An image reading apparatus 200A configured to read an image of an original and an automatic original feeding apparatus 200B configured to feed the original are disposed on an upper portion of the apparatus main body 1A. The apparatus main body 1A is provided with an image forming portion 1B configured to form an image on a recording medium (hereinafter referred to as a sheet) S, a feeding portion 20 configured to feed the sheet S, and a fixing portion 36 configured to fix a toner image formed on the sheet S.

The image forming portion 1B is provided with process cartridges 25 configured to form toner images of four colors of yellow, magenta, cyan, and black, respectively, which are detachably mounted to the apparatus main body 1A. The process cartridges 25 include photosensitive drums 26 (26Y, 26M, 26C 26 K), respectively. The image forming portion 1B includes a scanner unit 28 disposed vertically below the process cartridges 25. The scanner unit 28 irradiates the photosensitive drums 26 with laser beams based on image information to form electrostatic latent images on the photosensitive drums 26. Each of the process cartridges 25 includes, around the photosensitive drum 26, a charging device 27 configured to uniformly charge a surface of the photosensitive drum 26, a developing device 29 configured to make toner adhere to the electrostatic latent image to develop the image as a toner image, and a drum cleaner 29a.

Primary transfer rollers 31 are disposed inside an intermediate transfer belt 30 so as to be opposed to the photosensitive drums 26, respectively. The primary transfer rollers 31 apply primary transfer biases to the intermediate transfer belt 30 so that the toner images of respective colors on the photosensitive drums 26 are sequentially transferred to the intermediate transfer belt 30, thereby a full-color toner image is formed on the intermediate transfer belt 30. A secondary transfer portion 32 transfers the full-color toner image formed on the intermediate transfer belt 30 to the sheet S. The secondary transfer portion 32 includes a drive roller 32b that also serves as a secondary transfer inner roller rotated by a drive gear (not shown), and a secondary transfer roller 32a. The fixing portion 36 heats and pressurizes the toner image transferred on the sheet S to fix the toner image to the sheet S. The fixing portion 36 has a heating roller 34 and a pressure roller 35 in pressure contact with the heating roller 34. The feeding portion 20 includes a feeding cassette 22a detachably mounted to the apparatus main body 1A and a pickup roller 22b. A manual feeding portion 45 feeds a sheet S placed on the manual feeding portion 45.

### (Image Forming Operation)

Next, an image forming operation of the image forming apparatus 1 will be described with reference to FIG. 1. In a case in which an original is placed on a contact glass 303, an image reading portion 304 scans in the arrow direction under the contact glass 303. Light emitted from a light source 304a is reflected by a surface of the original and then reflected by mirrors 304b to enter a charge coupled device (hereinafter referred to as CCD) 333. The CCD 333 converts a received reflected light into an electric signal (image signal) as image information. In a case in which an image of an original set on the automatic original feeding apparatus 200B is read, the image reading portion 304 is stopped at a position shown in FIG. 1. The originals are separated by the automatic original feeding apparatus 200B and conveyed one by one to the contact glass 303. The original is conveyed by the automatic original feeding apparatus 200B on the surface of the contact glass 303 opposite to the image reading portion 304. The image reading portion 304 reads the image of the original conveyed by the automatic original feeding apparatus 200B. The image forming apparatus 1 functions as a copying machine when the image signal from the CCD 333 is input to an image processing portion (not shown), and functions as a printer when an image signal from a personal computer is input to the image processing portion (not shown).

The image information converted into the electric signal by the CCD 333 is processed by the image processing portion (not shown) and then transmitted to the scanner unit 28. The scanner unit 28 emits a laser beam according to the electric signal as image information. The laser beam is irradiated onto the surface of the photosensitive drum 26. The surface of the photosensitive drum 26 is uniformly charged to a predetermined potential of a predetermined polarity by the charging device 27. The laser beam emitted from the scanner unit 28 is irradiated onto the uniformly charged surface of the photosensitive drum 26 so that an electrostatic latent image is formed on the surface of the photosensitive drum 26. The developing device 29 develops the electrostatic latent image with toner to form a toner image.

In a case in which a color image is to be formed, for example, the photosensitive drum 26Y is first irradiated with a laser beam according to an image signal of a yellow component color of an original from the scanner unit 28 to form a yellow electrostatic latent image on the surface of the photosensitive drum 26Y. The developing device 29 develops the yellow electrostatic latent image with yellow toner from a toner containing portion 29b to form a yellow toner image.

The yellow toner image reaches a primary transfer portion in which the photosensitive drum 26Y and the intermediate transfer belt 30 abut against each other as the photosensitive drum 26Y rotates. The yellow toner image on the photosensitive drum 26Y is transferred onto the intermediate transfer belt 30 by the primary transfer bias applied to the primary transfer roller 31. The yellow toner image on the intermediate transfer belt 30 reaches a primary transfer portion in which the photosensitive drum 26M and the intermediate transfer belt 30 abut against each other as the intermediate transfer belt 30 rotates. By this time, a magenta toner image formed on the photosensitive drum 26M by the same method as described above is transferred and superposed on the yellow toner image on the intermediate transfer belt 30. Similarly, as the intermediate transfer belt 30 moves, a cyan toner image and a black toner image are transferred in primary transfer portions, respectively, and superposed on the yellow toner image and the magenta toner image. Thus, a color toner image is formed on the intermediate transfer belt 30. After the toner images are transferred, the toners remaining on the surfaces of the photosensitive drums 26 are removed by the drum cleaners 29a, respectively. The removed toners are recovered in a recovery toner container 13.

In parallel with the toner image forming operation, the sheet S contained in the feeding cassette 22a is fed by the pickup roller 22b and reaches a registration roller pair 24. Alternatively, the sheet S placed on the manual feeding portion 45 reaches the registration roller pair 24. The registration roller pair 24 conveys the sheet S to the secondary transfer portion 32 so that a leading edge of the sheet S coincides with a leading edge of the toner image on the intermediate transfer belt 30 at the secondary transfer portion 32. In the secondary transfer portion 32, the toner images of four colors on the intermediate transfer belt 30 are collectively transferred onto the sheet S by the secondary transfer bias applied to the secondary transfer roller 32a.

The sheet S to which the toner image has been transferred is conveyed to the fixing portion 36. When the sheet S passes through a nip formed by the heating roller 34 and the pressure roller 35 in pressure contact with the heating roller 34, the unfixed toner image on the sheet S is heated and pressurized. As a result, the color print image is fixed to the sheet S as a permanent image. The sheet S to which the color print image has been fixed is conveyed to a discharge roller pair 38 (reverse roller pair), which can forwardly (in a first rotation direction) and reversely (in a second rotation direction opposite to the first rotation direction) rotate, by a discharge upstream roller pair 37 (conveyance roller pair) as a conveyance unit. The sheet S is discharged to a discharge tray 40 by the discharge roller pair 38 and stacked on the discharge tray 40.

The image forming apparatus 1 can form images on both sides of the sheet S. In a case in which images are formed on both sides of the sheet S, before the sheet S having the image formed on the first side is discharged to the discharge tray 40 by the discharge roller pair 38, the discharge roller pair 38 is reversely rotated to allow the sheet S to enter a reverse conveyance path R which is a sheet conveyance path. The sheet S entering the reverse conveyance path R is conveyed to the registration roller pair 24 by a discharge downstream roller pair 41 (another conveyance unit) and conveyance roller pairs 42 and 43 provided in the reverse conveyance path R. The sheet S is again conveyed to the image forming portion 1B by the registration roller pair 24, and a toner image is formed on a second side of the sheet S. The sheet S having the toner image formed on the second side is conveyed to the fixing portion 36. The fixing portion 36 fixes the toner image to the second side of the sheet S to form an image on the second side. The sheet S on which the images have been formed on both sides is discharged to the discharge tray 40 by the discharge roller pair 38.

### (Reverse Discharge Portion)

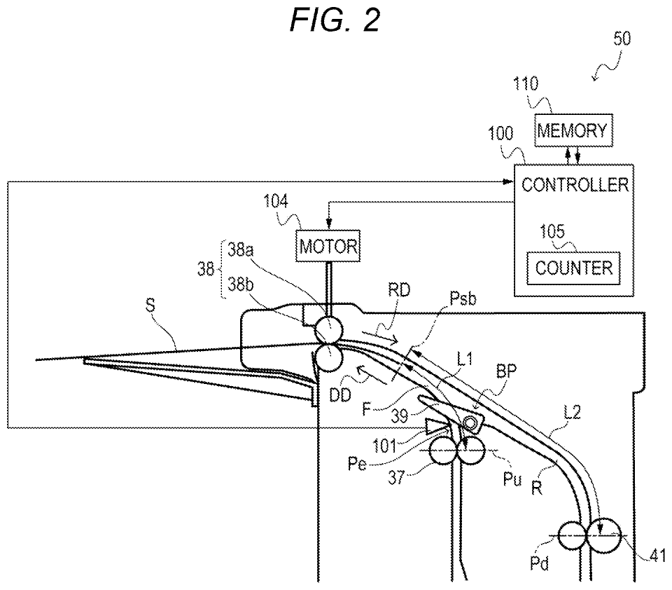

Next, with reference to FIG. 2, a reverse discharge portion 50 configured to change the conveyance direction of the sheet S will be described. FIG. 2 is a view showing the reverse discharge portion 50 of the image forming apparatus 1. In a case in which images are formed on both sides of the sheet S, the sheet S having an image formed on one side thereof is conveyed to the discharge roller pair 38 (roller pair) in a discharge direction DD (first direction) along a forward conveyance path F (discharge conveyance path) by the discharge upstream roller pair 37 as the conveyance unit. The discharge upstream roller pair 37 is disposed upstream of the discharge roller pair 38 in the discharge direction DD. A reverse flapper 39 is disposed at a branch-off portion BP of the forward conveyance path F and the reverse conveyance path R, and is rotated by the sheet S conveyed in the discharge direction DD abutting against the reverse flapper 39. When a leading edge of the sheet S passes through the reverse flapper 39 and enters a nip of the discharge roller pair 38, the sheet S is conveyed in the discharge direction DD by the discharge roller pair 38 and the discharge upstream roller pair 37. When a trailing edge of the sheet S passes through the reverse flapper 39 and reaches a switchback position Psb (change position), the forward rotation of the discharge roller pair 38 is stopped and the reverse rotation is started (switchback is performed). The sheet S is conveyed by the discharge roller pair 38 in a reverse direction RD (second direction) opposite to the discharge direction DD, with the trailing edge in the discharge direction DD serving as the leading edge. After the switchback, the sheet S is conveyed along the reverse conveyance path R switched by the reverse flapper 39 and enters the discharge downstream roller pair 41, which is another conveyance roller pair disposed downstream of the discharge roller pair 38 in the reverse direction RD.

The reverse discharge portion 50 is provided with a sheet sensor 101 (detection unit) configured to optically detect the sheet S at a detection position Pe downstream of the discharge upstream roller pair 37 in the discharge direction DD and in the vicinity of the discharge upstream roller pair 37. The discharge roller pair 38 includes a discharge drive roller 38a (drive roller) and a discharge driven roller 38b (driven roller). A motor 104 as a discharge roller drive unit is connected to the discharge drive roller 38a to transmit drive to the discharge drive roller 38a.

The reverse discharge portion 50 is provided with a controller 100 configured to control timing for reversing the rotation of the discharge roller pair 38. A memory 110, the sheet sensor 101, and the motor 104 are electrically connected to the controller 100. In the first embodiment, a pulse motor is used as the motor 104. The controller 100 transmits a pulse signal as a drive signal for driving the motor 104 to the motor 104. The motor 104 rotates by a predetermined amount according to the pulse signal. The controller 100 incorporates a counter 105 configured to count the number of pulses of the pulse signal.

In the switchback operation, fluctuations in the attitude of the sheet S with respect to the discharge direction DD is more likely to occur in a case in which the sheet S is conveyed by only the discharge roller pair 38 than in a case in which the sheet S is conveyed by both the discharge roller pair 38 and the discharge upstream roller pair 37. Similarly, fluctuations in the attitude of the sheet S with respect to the reverse direction RD are more likely to occur in a case in which the sheet S is conveyed by only the discharge roller pair 38 than in a case in which the sheet S is conveyed by both the discharge roller pair 38 and the discharge downstream roller pair 41.

### (Sheet Sensor)

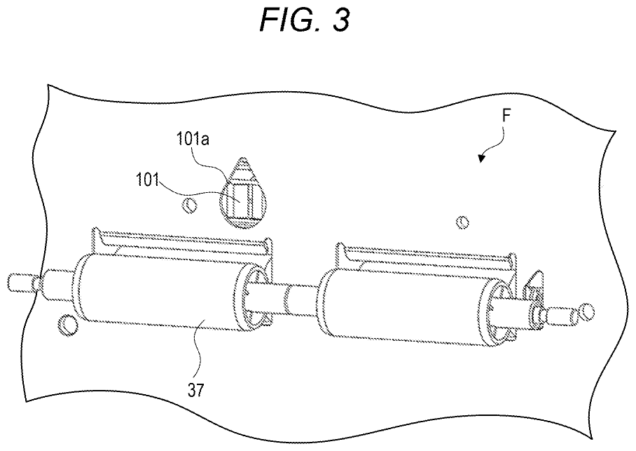

Next, the configuration of the sheet sensor 101 will be described with reference to FIG. 3. FIG. 3 is a view showing the sheet sensor 101 and the discharge upstream roller pair 37. In the first embodiment, a reflective photosensor is used as the sheet sensor 101. The forward conveyance path F is provided with a detection hole 101a. The sheet sensor 101 is disposed in the vicinity of the detection hole 101a on the opposite side with respect to the forward conveyance path F. Light emitted from the sheet sensor 101 enters the forward conveyance path F through the detection hole 101a. When the sheet S conveyed in the forward conveyance path F passes a position facing the sheet sensor 101, the light from the sheet sensor 101 is reflected by the sheet S and enters the sheet sensor 101. The sheet sensor 101 detects a light amount of the reflected light received by the sheet sensor 101 and transmits a detection signal to the controller 100. The controller 100 detects a timing when the leading edge of the sheet S passes the sheet sensor 101 based on a rising edge of the light amount of the reflected light received by the sheet sensor 101. The controller 100 detects a timing when the trailing edge of the sheet S passes the sheet sensor 101 based on a falling edge of the light amount of the reflected light received by the sheet sensor 101.

### (Fluctuation in Skew Amount)

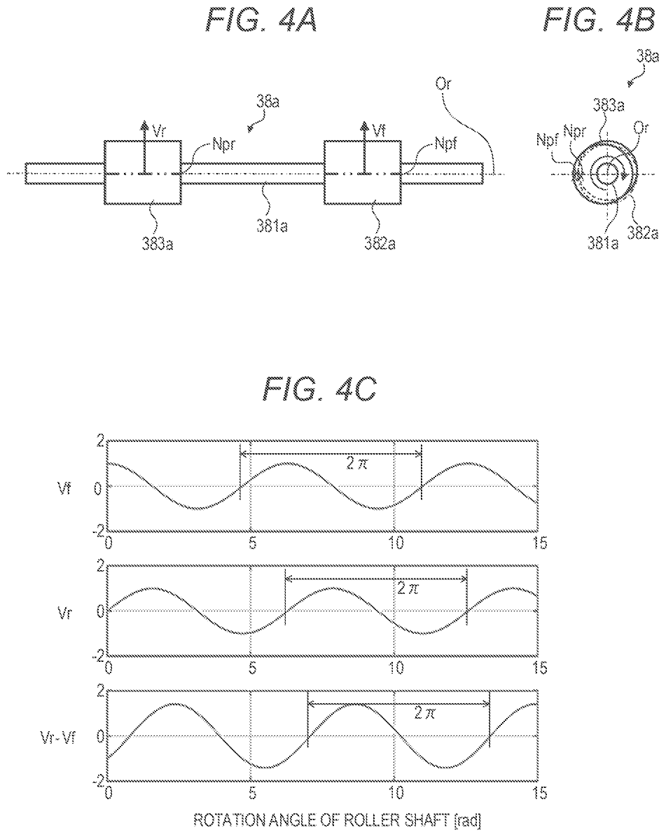

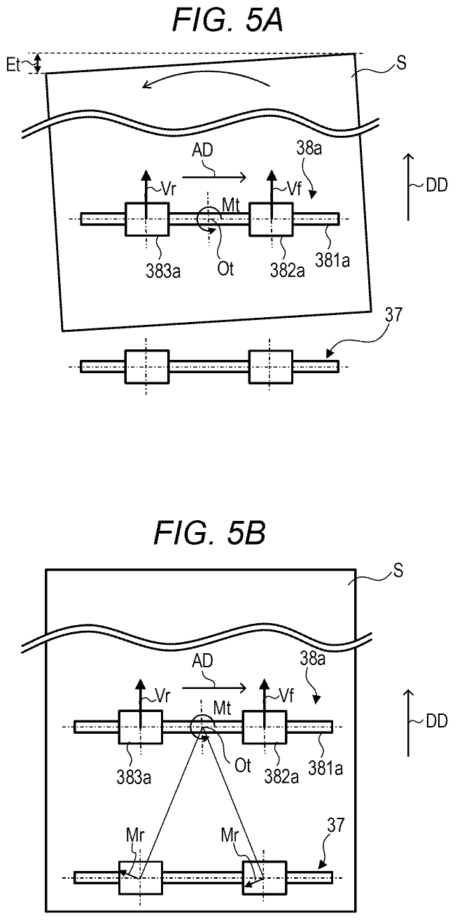

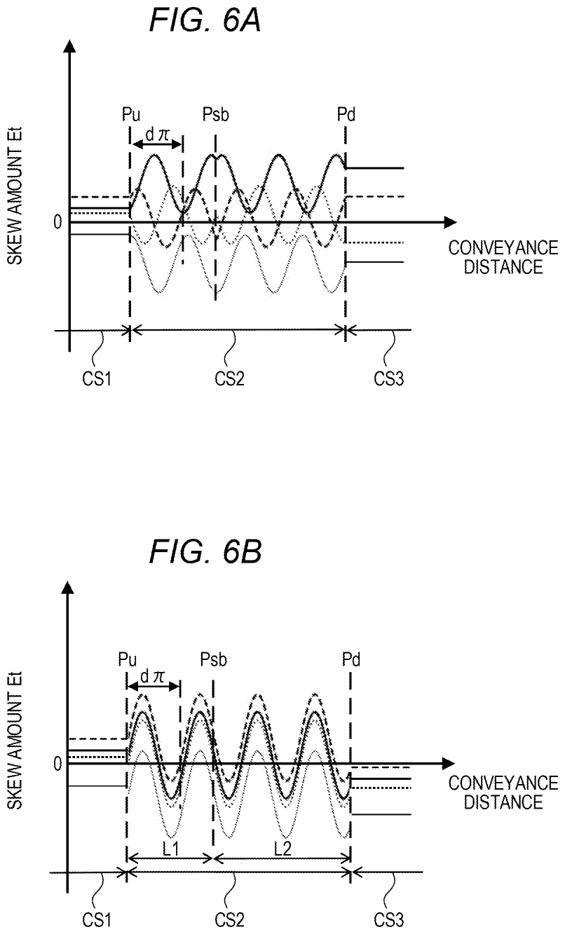

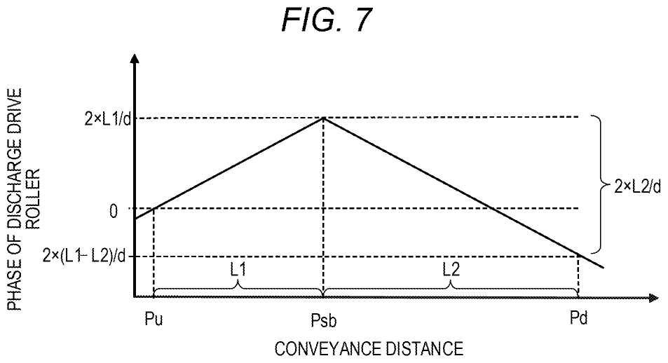

With reference to FIG. 4A, FIG. 4B, FIG. 4C, FIG. 5A, FIG. 5B, FIG. 6A, FIG. 6B, and FIG. 7, the fluctuation in the skew amount of the sheet S occurring in one rotation period of the discharge drive roller 38a will be described. FIG. 4A, FIG. 4B, and FIG. 4C are explanatory views of a circumferential velocity fluctuation that occurs in one rotation period of the discharge drive roller 38a. FIG. 4A is a front view of the discharge drive roller 38a. FIG. 4B is a side view of the discharge drive roller 38a. The discharge drive roller 38a comprises a front side rubber member 382a, a back side rubber member 383a, and a roller shaft 381a which is press-fitted into the front side rubber member 382a and the back side rubber member 383a in an axial direction of the front side rubber member 382a and the back side rubber member 383a. The roller shaft 381a is rotatably supported by a rotation support member (not shown) and connected to a drive transmission unit (not shown). The motor 104 is connected to the drive transmission unit (not shown). The roller shaft 381a is rotated about an axis center Or by the driving force from the motor 104. The front side rubber member 382a and the back side rubber member 383a nip the sheet S at nip positions Npf and Npr, respectively. The sheet S is conveyed at a circumferential velocity Vf at the nip position Npf. The sheet S is conveyed at a circumferential velocity Vr at the nip position Npr.

The front side rubber member 382a and the back side rubber member 383a are press-fitted onto the roller shaft 381a with an axis center of the front side rubber member 382a and an axis center of the back side rubber member 383a being out of alignment with the axis center Or of the roller shaft 381a (so-called misalignment in centering) due to fluctuation in machining accuracy. Therefore, a distance between the nip position Npf and the axis center Or and a distance between the nip position Npr and the axis center Or, that is, a radius of rotation of the nip position Npf and a radius of rotation of the nip position Npr vary as the roller shaft 381a rotates. As a result, the circumferential velocity Vf at the nip position Npf and the circumferential velocity Vr at the nip position Npr also vary as the roller shaft 381a rotates.

FIG. 4C is a view showing fluctuations in the circumferential velocities Vf and Vr and a fluctuation in a difference velocity Vr-Vf between the circumferential velocities Vf and Vr with respect to a rotation angle of the roller shaft 381a. Since the circumferential velocities Vf and Vr vary as the roller shaft 381a rotates, the circumferential velocities Vf and Vr vary periodically for each rotation (2n) of the roller shaft 381a. In the first embodiment, the front side rubber member 382a and the back side rubber member 383a are misalignment in centering in different phases with respect to the roller shaft 381a. As a result, the phases of the fluctuations in the circumferential velocities Vf and Vr are different. Therefore, according to the geometry, the difference velocity Vr-Vf between the circumferential velocities Vr and Vf varies periodically for each rotation (2n) of the roller shaft 381a in the same manner as the circumferential velocities Vr and Vf. As the difference velocity Vr-Vf periodically varies, the attitude of the sheet S with respect to the conveyance direction periodically varies.

FIG. 5A and FIG. 5B are explanatory views of a fluctuation in a skew amount of the sheet S caused by the periodic fluctuation in the difference velocity Vr-Vf FIG. 5A shows a sheet S being conveyed by only the discharge roller pair 38. When a difference occurs between the circumferential velocities Vf and Vr, a turning moment Mt around a central position Ot between the front side rubber member 382a and the back side rubber member 383a in an axial direction AD of the roller shaft 381a acts on the sheet S. The sheet S is turned around the central position Ot by the turning moment Mt, and the attitude of the sheet S is tilted with respect to the discharge direction DD, so that the sheet S is fed askew. When the difference velocity Vr-Vf periodically varies for each rotation of the roller shaft 381a, the turning moment Mt also periodically varies synchronously, and as a result, the skew amount Et of the sheet S also periodically varies.

On the other hand, in a case in which a sheet S is nipped and conveyed by a plurality of roller pairs, the behavior of the sheet S is different from that in the case in which the sheet S is nipped and conveyed by only the discharge roller pair 38. FIG. 5B shows a sheet S being conveyed by the discharge roller pair 38 and the discharge upstream roller pair 37. In the case shown in FIG. 5B, similarly to the case shown in FIG. 5A, the difference between the circumferential velocities Vf and Vr causes the turning moment Mt around the central position Ot to act on the sheet S. However, at the nip positions of the discharge upstream roller pair 37, frictional resistances are generated between the discharge upstream roller pair 37 and the sheet S, and resistance moments Mr are generated in a direction to cancel the turning moment Mt. As a result, the total moment acting on the sheet S becomes almost 0 (Mt−2×Mr≈0), and the generated skew amount Et becomes small. Therefore, the periodic skew fluctuation of the sheet S is particularly large in a section in which the sheet S is conveyed by only the discharge roller pair 38.

FIG. 6A and FIG. 6B are views showing the fluctuation in the skew amount Et of the sheet S during the switchback (during the surface reverse). FIG. 6A is a view showing a relationship between a conveyance distance of the sheet S and the skew amount Et in the conventional switchback conveyance. In FIG. 6A, the relationships between the conveyance distances of the plurality of sheets S and the skew amounts Et are represented by a thick line, a thin line, a dashed line, and a dotted line, respectively. In a first conveyance section CS1 in which the sheet S is conveyed by both the discharge roller pair 38 and the discharge upstream roller pair 37, the skew amount Et with respect to the conveyance distance of the sheet S is substantially constant. In a second conveyance section CS2 in which the sheet S is conveyed by only the discharge roller pair 38, the skew amount Et with respect to the conveyance distance of the sheet S changes according to the phase of the discharge drive roller 38a. In a third conveyance section CS3 in which the sheet S is conveyed by both the discharge roller pair 38 and the discharge downstream roller pair 41, the skew amount Et with respect to the conveyance distance of the sheet S is substantially constant.

The second conveyance section CS2 in which the sheet S is conveyed by only the discharge roller pair 38 is a section from a time when the trailing edge of the sheet S leaves a position Pu of the discharge upstream roller pair 37 to a time when the leading edge of the switched back sheet S enters a position Pd of the discharge downstream roller pair 41. In the second conveyance section CS2, the skew amount Et varies greatly and periodically. The period of the fluctuation in the skew amount Et corresponds to one rotation period of the discharge drive roller 38a. The conveyance distance during one rotation of the discharge drive roller 38a is approximately “dπ”. “d” is a diameter of the discharge drive roller 38a. “dπ” is a circumferential length of the discharge drive roller 38a.

Since the phase of the discharge drive roller 38a when the trailing edge of the sheet S leaves the position Pu of the discharge upstream roller pair 37 is different in each of the plurality of sheets S, the skew amount Et at the position Pu is also different in each of the plurality of sheets S. In any of the sheets S, the skew amount Et at a position at which the trailing edge of the sheet S is conveyed by the circumferential length “dπ” of the discharge drive roller 38a from the position Pu at which the trailing edge of the sheet S has left the discharge upstream roller pair 37 is substantially the same as the skew amount Et at the position Pu. However, since the skew amount Et at a position other than the position at which the sheet is conveyed by a conveyance distance of an integer multiple of the circumferential length “dπ” is different from the skew amount Et at the position Pu, the skew amount Et for each sheet S varies greatly.

In the conventional art, a phase of the discharge drive roller 38a at the timing when the trailing edge of the sheet S has left the position Pu is different from a phase of the discharge drive roller 38a at the timing when the leading edge of the switched back sheet S enters the position Pd. Accordingly, in the conventional art, the skew amount Et varies greatly for each sheet S. Therefore, in the conventional art, the accuracy of the image formation position with respect to the sheet S in the double-sided image formation is lowered.

FIG. 7 is a view showing a relationship between the conveyance distance of the sheet S and the phase of the discharge drive roller 38a. In FIG. 7, the phase of the discharge drive roller 38a at the position Pu is set to “0”. In a case in which the sheet S is conveyed from the position Pu toward the switchback position Psb by the forward rotation of the discharge drive roller 38a, the phase of the discharge drive roller 38a is made positive.

As shown in FIG. 2, a conveyance distance from the position Pu to the switchback position Psb is defined as a first distance L1. Assuming that the phase of the discharge drive roller 38a when the trailing edge of the sheet S has left the position Pu is “0”, the phase of the discharge drive roller 38a when the trailing edge of the sheet S reaches the switchback position Psb is 2×L1/d (=2π×L1/dπ). As shown in FIG. 2, a conveyance distance from the switchback position Psb to the position Pd is defined as a second distance L2. The phase of the discharge drive roller 38a when the leading edge of the sheet S conveyed in the reverse direction RD after the switchback reaches the position Pd is 2×(L1−L2)/d because the phase of the discharge drive roller 38a rotates reversely by 2×L2/d from 2×L1/d.

Therefore, a difference between the phase “0” of the discharge drive roller 38a when the trailing edge of the sheet S has left the position Pu and the phase 2×(L1−L2)/d of the discharge drive roller 38a when the leading edge of the switched back sheet S enters the position Pd is expressed by the following Equation (1).

2×(L1−L2)/d Equation (1)

If the phase difference is an integer multiple of “2π”, the phase of the discharge drive roller 38a when the trailing edge of the sheet S has left the position Pu is the same as the phase of the discharge drive roller 38a when the leading edge of the switched back sheet S enters the position Pd.

2×(L1−L2)/d=2πn

“n” is a predetermined integer value. In the first embodiment, the first distance L1 and the second distance L2 may be set to satisfy the following equation.

|L1−L2|=ndπ

“dπ” is the circumferential length of the discharge drive roller 38a. The first distance L1 and the second distance L2 may be set such that an absolute value of a difference between the first distance L1 and the second distance L2 is an integer multiple of the circumferential length of the discharge drive roller 38a.

FIG. 6B is a view showing a relationship between the conveyance distance and the skew amount Et in the switchback conveyance by the reverse discharge portion 50 of the first embodiment. In FIG. 6B, the relationships between the conveyance distances and the skew amounts Et of the plurality of sheets S are represented by a thick line, a thin line, a broken line, and a dotted line, respectively. According to the first embodiment, the phase of the discharge drive roller 38a when the trailing edge of the sheet S has left the position Pu is substantially the same in all of the sheets S. Therefore, the skew amounts Et of the plurality of sheets S change similarly in the second conveyance section CS2 in which the sheets S are conveyed by only the discharge roller pair 38, and the fluctuation of the skew amount Et for each sheet S is reduced.

### (Control Operation)

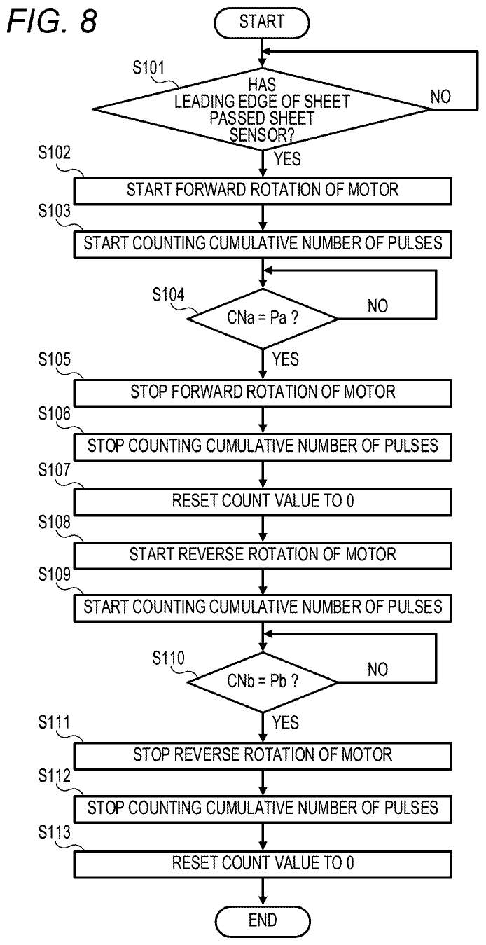

Next, with reference to FIG. 8, a control operation performed by the controller 100 in order to align the phase of the discharge drive roller 38a at the timing when the trailing edge of the sheet S has left the position Pu will be described. FIG. 8 is a flowchart showing the control operation of the discharge drive roller 38a performed by the controller 100 according to the first embodiment.

When the control operation of the discharge drive roller 38a is started, the controller 100 determines whether or not the leading edge of the sheet S has passed the sheet sensor 101 based on the detection result of the sheet sensor 101 (S101). In a case in which it is determined that the leading edge of the sheet S has passed the sheet sensor 101 (YES in S101), the controller 100 starts the forward rotation (rotation in the first rotation direction) of the motor 104 in order to rotate the discharge drive roller 38a forwardly (S102). At the same time, the controller 100 starts counting a cumulative number of pulses of the pulse signal for rotating the motor 104 forwardly by the counter 105 (S103). The controller 100 determines whether or not a first count value CNa of the cumulative number of pulses reaches a first number of pulses Pa so that the condition indicated by the following Equation (2) is satisfied (S104).

CNa=Pa Equation (2)

The first number of pulses Pa is a pulse number PN1 of the pulse signal required to rotate the motor 104 from a time when the leading edge of the sheet S conveyed in the discharge direction DD passes the sheet sensor 101 to a time when the trailing edge of the sheet S reaches the switchback position Psb. The first number of pulses Pa may be larger than the pulse number PN1. The first number of pulses Pa as a first rotation amount is previously set to a pulse number equal to or larger than the pulse number PN1. The first number of pulses Pa may include a plurality of first setting values set according to a plurality of sizes of the sheet S. In a case in which the first count value CNa of the cumulative number of pulses reaches the first number of pulses Pa, it is determined that the trailing edge of the sheet S has reached the switchback position Psb (reversal position). In a case in which the first count value CNa becomes the first number of pulses Pa (YES in S104), the controller 100 stops the forward rotation of the motor 104 (S105).

The controller 100 controls the motor 104 under the condition indicated by Equation (2) so that it is possible to stop the forward rotation of the motor 104 in the case in which the first count value CNa becomes the first number of pulses Pa. There is a possibility that the first count value CNa deviates from the first number of pulses Pa due to a delay in control. However, the amount of deviation between the first count value CNa and the first number of pulses Pa in this case can be ignored as an error.

After the forward rotation of the motor 104 is stopped, the controller 100 stops counting the cumulative number of pulses by the counter 105 (S106). The controller 100 resets the count value of the counter 105 to “0” (S107). The controller 100 starts the reverse rotation (rotation in the second rotation direction) of the motor 104 in order to reverse the discharge drive roller 38a as a switchback process (S108). At the same time, the controller 100 causes the counter 105 to start counting the cumulative number of pulses of the pulse signal for reversing the motor 104 (S109). The controller 100 determines whether or not the second count value CNb of the cumulative number of pulses becomes a second number of pulses Pb as indicated by the following Equation (3) (S110).

CNb=Pb Equation (3)

The second number of pulses Pb is a pulse number PN2 of a pulse signal necessary for rotating the motor 104 from a time when the reverse rotation of the discharge drive roller 38a is started to a time when the trailing edge of the sheet S conveyed in the reverse direction RD leaves the discharge roller pair 38. The second number of pulses Pb may be larger than the pulse number PN2. The second number of pulses Pb as a second rotation amount is previously set to a pulse number equal to or larger than the pulse number PN2. The second number of pulses Pb may include a plurality of second setting values set according to a plurality of sizes of the sheet S. In a case in which the second count value CNb reaches the second number of pulses Pb, it is determined that the trailing edge of the sheet S has passed the discharge roller pair 38. In a case in which the second count value CNb becomes the second number of pulses Pb (YES in S110), the controller 100 stops the reverse rotation of the motor 104 (S111).

The controller 100 controls the motor 104 under the condition indicated by Equation (3) so that it is possible to stop the reverse rotation of the motor 104 in the case in which the second count value CNb becomes the second number of pulses Pb. There is a possibility that the second count value CNb deviates from the second number of pulses Pb due to a delay in control. However, the amount of deviation between the second count value CNb and the second number of pulses Pb in this case can be ignored as an error.

Here, the first number of pulses Pa and the second number of pulses Pb used in Equation (2) and Equation (3) as the stop conditions of the motor 104 satisfy a condition indicated by the following Equation (4).

|Pa−Pb|=Pr×n Equation (4)

“n” is a predetermined integer value. “n” may be set to a different integer value according to the size of the sheet S. The predetermined number of pulses Pr (predetermined rotation amount) is a number of pulses per one rotation of the discharge drive roller 38a. By controlling the stop of the forward rotation and the reverse rotation of the motor 104 using the first number of pulses Pa and the second number of pulses Pb satisfying the condition indicated by Equation (4), the discharge drive roller 38a can be stopped at a position rotated “n” times after the start of driving the discharge drive roller 38a for each sheet. That is, in the switchback operation of the sheet S, the discharge drive roller 38a can be stopped at the same phase every time.

After the reverse rotation of the motor 104 is stopped, the controller 100 stops counting the cumulative number of pulses by the counter 105 (S112). The controller 100 resets the count value of the counter 105 to “0” (S113). The controller 100 ends the control operation of the discharge drive roller 38a.

The controller 100 controls the discharge drive roller 38a according to the flowchart shown in FIG. 8 so that the phase of the discharge drive roller 38a at the timing when the trailing edge of the sheet S conveyed in the discharge direction DD leaves the position Pu can be made the same each time. Further, the phase of the discharge drive roller 38a at the timing when the leading edge of the sheet S conveyed in the reverse direction RD enters the position Pd can be made the same each time. Thus, even in the case in which the skew amount Et of the sheet S changes in one rotation period of the discharge drive roller 38a, fluctuations in the attitude of the sheet S with respect to the conveyance direction can be reduced. According to the first embodiment, fluctuations in the attitude of the sheet S in the case in which the conveyance direction of the sheet S is reversed can be reduced.

### Second Embodiment

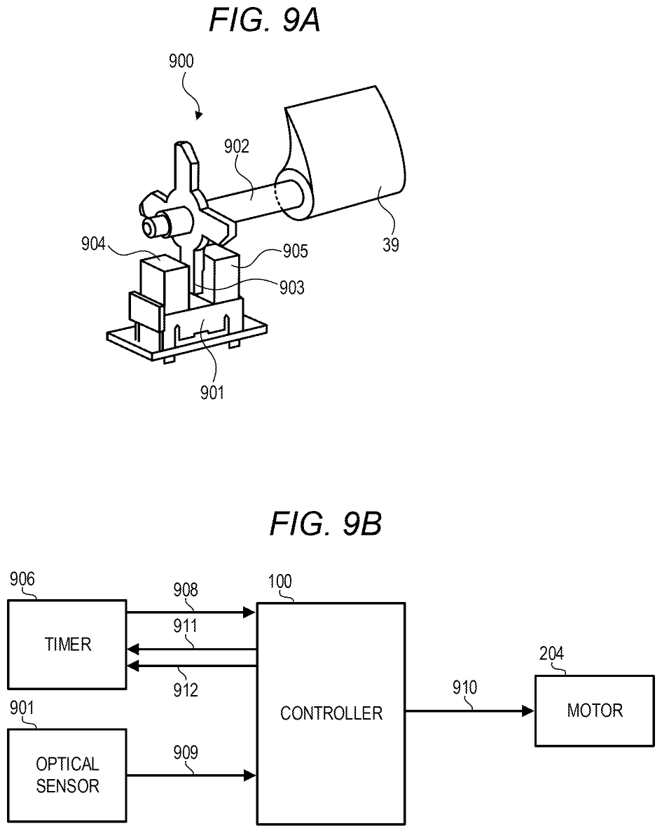

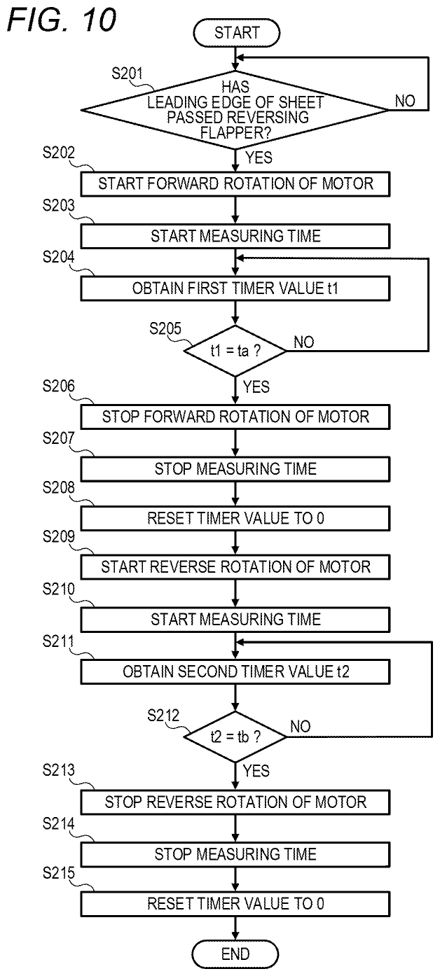

Next, a second embodiment will be described with reference to FIG. 9A, FIG. 9B, and FIG. 10. In the second embodiment, the same structures as those in the first embodiment are denoted by the same reference numerals and the description thereof will be omitted. Since the image forming apparatus 1, the image forming operation, and the reverse discharge portion 50 of the second embodiment are the same as those of the first embodiment, description thereof will be omitted. The second embodiment differs from the first embodiment in an edge detecting portion 900 configured to mechanically detect a sheet S, a motor 204, and a control operation by the controller 100. The differences will be mainly described below.

### (Edge Detecting Portion)

With reference to FIG. 9A and FIG. 9B, the edge detecting portion 900 (detection unit) configured to detect the sheet S at the detection position Pe (FIG. 2) will be described. FIG. 9A and FIG. 9B are explanatory views of the edge detecting portion 900. FIG. 9A is a view showing the configuration of the edge detecting portion 900. The edge detecting portion 900 has the reverse flapper 39, an optical sensor 901, a rotary shaft 902, and a light blocking portion 903. The rotary shaft 902 supports the reverse flapper 39 and the light blocking portion 903. The rotary shaft 902 and the light blocking portion 903 rotate in conjunction with the rotation of the reverse flapper 39. The optical sensor 901 is disposed in the vicinity of the light blocking portion 903. In the second embodiment, the optical sensor 901 is a transmissive photosensor. The optical sensor 901 has a light emitting portion 904 and a light receiving portion 905. The light receiving portion 905 receives the light emitted from the light emitting portion 904 and outputs a signal to the controller 100. The light blocking portion 903 is disposed to be configured to assume a position for blocking an optical path between the light emitting portion 904 and the light receiving portion 905 and a position for retreating from the optical path. When the light blocking portion 903 rotates in conjunction with the rotation of the reverse flapper 39 and the light blocking portion 903 retreats from the optical path between the light emitting portion 904 and the light receiving portion 905, the light receiving portion 905 detects the light from the light emitting portion 904. When the sheet S conveyed in the forward conveyance path F presses the reverse flapper 39 to rotate the reverse flapper 39, a signal transmitted from the optical sensor 901 to the controller 100 changes. Based on the signal from the optical sensor 901, the controller 100 detects a timing when the sheet S has passed the reverse flapper 39.

Next, the controller 100 configured to control the discharge roller pair 38 will be described with reference to FIG. 9 B. FIG. 9B is a block diagram of a control system according to a second embodiment. The controller 100 outputs a velocity command value 910 to the motor 204 as a discharge roller driving unit, and controls the discharge roller pair 38. In the second embodiment, a brushless motor is used as the motor 204. The controller 100 is electrically connected to a timer 906, the motor 204 and the optical sensor 901. The timer 906 has a function of measuring time. When the timer 906 receives a measurement start signal 911 from the controller 100, the timer 906 starts measuring the time. When the timer 906 receives a measurement stop signal 912 from the controller 100, the timer 906 stops measuring the time. When controlling the discharge roller pair 38, the controller 100 receives a leading edge arrival signal 909 notifying that the leading edge of the sheet S has been detected from the optical sensor 901 and a time signal 908 from the timer 906.

### (Control Operation)

Next, with reference to FIG. 10, a control operation performed by the controller 100 in order to align the phase of the discharge drive roller 38a at the timing when the trailing edge of the sheet S has left the position Pu will be described. FIG. 10 is a flowchart showing the control operation of the discharge drive roller 38a performed by the controller 100 according to the second embodiment.

When the control operation of the discharge drive roller 38a is started, the controller 100 determines whether or not the leading edge of the sheet S has passed the reverse flapper 39 based on the detection result of the edge detecting portion 900 (S201). When the sheet S is conveyed along the forward conveyance path F in the discharge direction DD and the leading edge of the sheet S has passed the reverse flapper 39, the optical sensor 901 transmits the leading edge arrival signal 909 to the controller 100. In a case in which the controller 100 receives the leading edge arrival signal 909, the controller 100 determines that the leading edge of the sheet S has passed the reverse flapper 39 (YES in S201), and the controller 100 advances the process to S202.

The controller 100 starts the forward rotation of the motor 204 at a first angular velocity “ωa” (first velocity) in order to rotate the discharge drive roller 38a forwardly (S202). At the same time, the controller 100 transmits the measurement start signal 911 to the timer 906 to get the timer 96 to start measuring the time (S203). The controller 100 obtains a first timer value t1 as the time signal 908 from the timer 906 at a predetermined time interval (S204). The controller 100 determines whether or not the first timer value t1 has become a first time value “ta” so that the condition indicated by the following Equation (5) is satisfied (S205).

t1=ta Equation (5)

The first time value “ta” is a time Pta from a time when the leading edge of the sheet S conveyed in the discharge direction DD passes the reverse flapper 39 to a time when the trailing edge of the sheet S reaches the switchback position Psb in a case in which the motor 204 rotates forwardly at the first angular velocity “ωa”. The first time value “ta” may be set to a time larger than the time Pta. The first time value “ta” as a first predetermined time is previously set to a time equal to or larger than the time Pta. In a case in which the first timer value t1 does not reach the first time value “ta” and the condition indicated by Equation (5) is not satisfied (NO in S205), the process returns to S204, and the controller 100 newly obtains the first timer value t1 from the timer 906. In a case in which the first timer value t1 becomes the first time value “ta” so that the condition indicated by Equation (5) is satisfied (YES in S205), the controller 100 stops the forward rotation of the motor 204 (S206). At this time, it is determined that the trailing edge of the sheet S has reached the switchback position Psb.

The controller 100 controls the motor 204 under the condition indicated by Equation (5) so that it is possible to stop the forward rotation of the motor 204 in the case in which the first timer value t1 becomes the first time value “ta”. There is a possibility that the first timer value t1 deviates from the first time value “ta” due to a delay in control. However, the amount of deviation between the first timer value t1 and the first time value “ta” in this case can be ignored as an error.

After the forward rotation of the motor 204 is stopped, the controller 100 transmits the measurement stop signal 912 to the timer 906 to cause the timer 906 to stop measuring the time (S207). The controller 100 resets the timer value of the timer 906 to “0” (S208). The controller 100 starts the reverse rotation of the motor 204 at a second angular velocity “ωb” (second velocity) in order to reverse the discharge drive roller 38a as the switchback process (S209). At the same time, the controller 100 transmits the measurement start signal 911 to the timer 906 to cause the timer 906 to start measuring the time (S210). The controller 100 obtains a second timer value t2 as the time signal 908 from the timer 906 (S211). The controller 100 determines whether or not the second timer value t2 becomes the second time value “tb” so that a condition indicated by the following Equation (6) is satisfied (S212).

t2=tb Equation (6)

The second time value “tb” is a time PTb from a time when the motor 204 starts reversing at the second angular velocity “ωb” to a time when the trailing edge of the sheet S conveyed in the reverse direction RD leaves the discharge roller pair 38. The second time value “tb” may be set to a time larger than the time PTb. The second time value “tb” as a second predetermined time is previously set to a time equal to or larger than the time PTb. In a case in which the second timer value t2 does not reach the second time value “tb” and the condition indicated by Equation (6) is not satisfied (NO in S212), the process returns to S211, and the controller 100 newly obtains the second timer value t2 from the timer 906. In a case in which the second timer value t2 becomes the second time value “tb” so that the condition indicated by Equation (6) is satisfied (YES in S212), the controller 100 stops the reverse rotation of the motor 204 (S213). At this time, it is determined that the trailing edge of the sheet S has left the discharge roller pair 38.

The controller 100 controls the motor 204 under the condition indicated by Equation (6) so that it is possible to stop the reverse rotation of the motor 204 in the case in which the second timer value t2 becomes the second time value “tb”. There is a possibility that the second timer value t2 deviates from the second time value “tb” due to a delay in control. However, the amount of deviation between the second timer value t2 and the second time value “tb” in this case can be ignored as an error.

Here, the first time value “ta” and the second time value “tb” used in Equation (5) and Equation (6) as the stop conditions of the motor 204 satisfy a condition indicated by the following Equation (7).

|ωa·ta−ωb·tb|=θr·n Equation (7)

“n” is a predetermined integer value. “n” may be set to a different integer value according to the size of the sheet S. The first angular velocity “ωa” is a command angular velocity of the motor 204 for conveying the sheet S in the forward conveyance path F. A product (first product) “ωa ta” of the first angular velocity “ωa” and the first time value “ta” is a rotation angle (first rotation angle) of the motor 204 during forward rotation. The second angular velocity “cob” is a command angular velocity of the motor 204 for conveying the sheet S in the reverse conveyance path R. A product (second product) “cob tb” of the second angular velocity “cob” and the second time value “tb” is a rotation angle (second rotation angle) of the motor 204 during reverse rotation. A predetermined rotation angle θr is a rotation angle of the motor 204 required to make one rotation of the discharge drive roller 38a. By controlling the stop of the forward rotation and the reverse rotation of the motor 204 using the first angular velocity “ωa” and the second angular velocity “ωb” satisfying the condition indicated by Equation (7), the discharge drive roller 38a can be stopped at a position rotated “n” times after the start of driving the discharge drive roller 38a for each sheet. That is, in the switchback operation of the sheet S, the discharge drive roller 38a can be stopped at the same phase every time.

After the reverse rotation of the motor 204 is stopped, the controller 100 transmits the measurement stop signal 912 to the timer 906 to cause the timer 906 to stop measuring the time (S214). The controller 100 resets the timer value of the timer 906 to “0” (S215). The controller 100 ends the control operation of the discharge drive roller 38a.

The controller 100 controls the discharge drive roller 38a according to the flowchart shown in FIG. 10 so that the phase of the discharge drive roller 38a at the timing when the trailing edge of the sheet S conveyed in the discharge direction DD leaves the position Pu can be made the same each time. Further, the phase of the discharge drive roller 38a at the timing when the leading edge of the sheet S conveyed in the reverse direction RD enters the position Pd can be made the same each time. Thus, even in the case in which the skew amount Et of the sheet S changes in one rotation period of the discharge drive roller 38a, fluctuations in the attitude of the sheet S with respect to the conveyance direction can be reduced. According to the second embodiment, fluctuations in the attitude of the sheet S in the case in which the conveyance direction of the sheet S is reversed can be reduced.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-132288, filed Aug. 16, 2021, which is hereby incorporated by reference herein in its entirety.

What is claimed is:

1. An image forming apparatus configured to form an image on a recording medium, the image forming apparatus comprising:
a reverse roller pair including a drive roller configured to rotate in a first rotation direction to convey the recording medium in a first direction and rotate in a second rotation direction opposite to the first rotation direction to convey the recording medium in a second direction opposite to the first direction, and a driven roller configured to be driven by a rotation of the drive roller, the recording medium being nipped by the drive roller and the driven roller and conveyed;
a motor configured to cause the drive roller to rotate in the first rotation direction and in the second rotation direction;
a conveyance roller pair disposed upstream of the reverse roller pair in the first direction and configured to nip and convey the recording medium in the first direction;
a detection unit disposed between the reverse roller pair and the conveyance roller pair and configured to detect the recording medium conveyed in the first direction by the conveyance roller pair; and
a controller configured to control the motor, in a case in which the recording medium is detected by the detection unit, to cause the drive roller to rotate in the first rotation direction by a first rotation amount, and thereafter to cause the drive roller to rotate in the second rotation direction by a second rotation amount,
wherein a difference between the first rotation amount and the second rotation amount is set to an integer multiple of a predetermined rotation amount of the motor, the predetermined rotation amount making the drive roller one rotation.

2. The image forming apparatus according to claim 1, wherein the first rotation amount is a rotation amount by which the motor is rotated in the first rotation direction to convey the recording medium in the first direction over a first conveyance section extending from a detection position at which a leading edge of the recording medium conveyed in the first direction by the conveyance roller pair is detected by the detection unit to a change position at which a conveyance direction of the recording medium is changed from the first direction to the second direction, and
wherein the second rotation amount is a rotation amount by which the motor is rotated in the second rotation direction to convey the recording medium in the second direction over a second conveyance section extending from the change position to a leaving position at which a trailing edge of the recording medium conveyed in the second direction by the reverse roller pair leaves the reverse roller pair.

3. The image forming apparatus according to claim 2, wherein the first rotation amount is a first number of pulses of a drive signal for rotating the motor in the first rotation direction to convey the recording medium in the first direction over the first conveyance section,
wherein the second rotation amount is a second number of pulses of the drive signal for rotating the motor in the second rotation direction to convey the recording medium in the second direction over the second conveyance section, and
wherein the predetermined rotation amount is a predetermined number of pulses of the drive signal by which the motor is rotated to make the drive roller one rotation.

4. The image forming apparatus according to claim 3, further comprising a counter configured to count a number of pulses of the drive signal,
wherein in a case in which a first count value counted by the counter from a time when a rotation in the first rotation direction of the motor is started reaches the first number of pulses, the controller stops the rotation in the first rotation direction of the motor, and
wherein in a case in which a second count value counted by the counter from a time when a rotation in the second rotation direction of the motor is started reaches the second number of pulses, the controller stops the rotation in the second rotation direction of the motor.

5. The image forming apparatus according to claim 2, wherein the first rotation amount is a first product of a first angular velocity and a first time value for which the motor is rotated in the first rotation direction at the first angular velocity to convey the recording medium in the first direction over the first conveyance section,
wherein the second rotation amount is a second product of a second angular velocity and a second time value for which the motor is rotated in the second rotation direction at the second angular velocity to convey the recording medium in the second direction over the second conveyance section, and
wherein the predetermined rotation amount is a predetermined rotation angle by which the motor is rotated to make the drive roller one rotation.

6. The image forming apparatus according to claim 5, further comprising a timer configured to measure a time for rotating the motor,
wherein in a case in which a first timer value measured by the timer from a time when a rotation in the first rotation direction of the motor is started reaches the first time value, the controller stops the rotation in the first rotation direction of the motor, and
wherein in a case in which a second timer value measured by the timer from a time when a rotation in the second rotation direction of the motor is started reaches the second time value, the controller stops the rotation in the second rotation direction of the motor.

7. The image forming apparatus according to claim 1, wherein the detection unit optically detects the recording medium.

8. The image forming apparatus according to claim 1, wherein the detection unit mechanically detects the recording medium.

9. The image forming apparatus according to claim 1, further comprising:
an image forming portion configured to form the image on the recording medium;
a discharge tray onto which the recording medium on which the image is formed by the image forming portion is discharged;
a discharge conveyance path in which the recording medium is conveyed in the first direction toward the discharge tray;
a reverse conveyance path in which the recording medium is conveyed in the second direction toward the image forming portion; and
a flapper disposed at a branch-off portion of the discharge conveyance path and the reverse conveyance path and configured to be rotated by the recording medium conveyed in the first direction abutting against the flapper,
wherein the detection unit detects a rotation of the flapper.

10. The image forming apparatus according to claim 1, wherein the first rotation amount includes a plurality of first setting values set according to a plurality of sizes of the recording medium, and
wherein the second rotation amount includes a plurality of second setting values set according to the plurality of sizes of the recording medium.

11. The image forming apparatus according to claim 1, further comprising another conveyance roller pair disposed downstream of the reverse roller pair in the second direction and configured to convey the recording medium in the second direction,
where a distance between a position of the conveyance roller pair and a reversal position of a trailing edge of the recording medium when a rotation in the first rotation direction of the motor which conveys the recording medium in the first direction is stopped is defined as a first distance,
wherein a distance between the reversal position and a position of the another conveyance roller pair is defined as a second distance, and
wherein the first distance and the second distance are set so that an absolute value of a difference between the first distance and the second distance is an integer multiple of the circumferential length of the drive roller.
